(19) United States
(12) Patent Application Publication
(10) Pub. No.: US 2026/0142689 A1
(43) Pub. Date: May 21, 2026

(54) QUASISTATIC AND RESONANT COMMUNICATION SYSTEM AND METHOD THROUGH A DISPLAY CHASSIS

(71) Applicant: Quasistatics Inc., West Lafayette, IN (US)

(72) Inventors: Shreyas Sen, West Lafayette, IN (US); Mohammad Abu Khater, Savoy, IL (US); Sayemul Islam, Lafayette, IN (US); Shovan Maity, West Lafayette, IN (US); David Yang, West Lafayette, IN (US)

(21) Appl. No.: 18/948,583

(22) Filed: Nov. 15, 2024

(51) Int. Cl. H04B 5/22; H04B 1/00

(52) U.S. Cl. CPC H04B 5/22; H04B 1/0078

(57) ABSTRACT

The present invention relates to quasistatic electromagnetic field communication system and method for performing quasistatic electromagnetic field communication through a chassis body of connected devices. The method includes transmitting, by a transmitting power source, data signals to connected devices through the chassis body associated with the connected devices. The method then includes performing, by the transmitting power source, excitation of the chassis body based on the transmission. Further the method includes creating, by the chassis body, one or more quasistatic field signals upon the excitation of the chassis body. Furthermore, the method includes receiving, by a receiving device, the one or more quasistatic field signals from the chassis body. Furthermore, the method includes performing, by the receiving device, filtration of the received one or more quasistatic field signals by filtering the one or more quasistatic field signals which are out of predefined operating range.

### TECHNICAL FIELD

Embodiments of the present disclosure generally relate to communication devices and technologies enabled with a display function, and more particularly relates to quasistatic electromagnetic field communication system (also referred herein as system) and method for performing quasistatic electromagnetic field communication through a chassis body of one or more connected devices.

### BACKGROUND

Wireless technology is one of the emerging technologies in which one or more devices get connected to each other through a wireless network such as Bluetooth or Wi-Fi for performing communication. However, in today's world, the plethora of one or more wireless devices in a household is stressing the spectrum availability. This issue is further exacerbated by that fact that one or more wirelessly transmitted signals can be sniffed, spoofed or triangulated by malicious actors.

Furthermore, the energy efficiency of wireless circuits has not scaled as much as their digital counterparts, which can be a bottleneck in the operation of energy-limited devices. On the other hand, wired devices can mitigate the security, spectrum and energy limitations, but at the cost of convenience and connector size and reliability issues.

Further, traditional methods of transmission of one or more wireless signals often leads to false reception of signals at different receivers. In other words, it is expected that some receivers receive unwanted signals from one or more transmitters which leads to interference of multiple signals. This may further lead to loss of channel for communication between one or more devices.

Therefore, a need exists for a novel solution that overcomes the limitations of both traditional wireless communication and wired communication. Therefore, there is a need in the art to provide a quasistatic electromagnetic field communication system and method for performing the quasistatic electromagnetic field communication using the chassis of a display (e.g., TV) of one or more devices connected to the system, to address the aforementioned deficiencies in the art.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

An aspect of the present disclosure provides a quasistatic electromagnetic field communication system. The quasistatic electromagnetic field communication system includes a transmitting power source comprising one or more optimizable transmitter electrodes, capacitively coupled with a chassis body of one or more connected devices. The transmitting power source is configured to transmit one or more data signals to the one or more connected devices through the chassis body associated with the one or more connected devices. Further the transmitting power source is configured to perform excitation of the chassis body based on the transmission. The quasistatic electromagnetic field communication system also includes the chassis body further comprising a conducting medium, in which the conducting medium of the chassis body is configured to create one or more quasistatic field signals upon the excitation of the chassis body. Furthermore, the quasistatic electromagnetic field communication system includes a receiving device comprising one or more optimizable receiver electrodes, capacitively coupled with the chassis body and an output panel of the one or more connected devices. Furthermore, the receiving device includes one or more filters coupled with the one or more optimizable receiver electrodes associated with the receiving device. The receiving device is configured to receive the one or more quasistatic field signals from the chassis body. Further, the receiving device is configured to perform filtration of the received one or more quasistatic field signals by eliminating the one or more quasistatic field signals which are out of predefined operating range. Subsequently, the receiving device is configured to receive the one or more transmitted data signals based on the performed filtration. Finally, the receiving device is configured to output the received one or more signals to the output panel of the one or more connected devices.

Another aspect of the present disclosure includes a method for performing the quasistatic electromagnetic field communication using a chassis body of one or more devices connected to the quasistatic electromagnetic field communication system. The method includes transmitting, by a transmitting power source, one or more data signals to one or more connected devices through the chassis body associated with the one or more connected devices. The method then includes performing, by the transmitting power source, excitation of the chassis body based on the transmission. Further, the method includes creating, by the chassis body, one or more quasistatic field signals upon the excitation of the chassis body. Furthermore, the method includes receiving, by a receiving device, the one or more quasistatic field signals from the chassis body. Furthermore, the method includes performing, by the receiving device, filtration of the received one or more quasistatic field signals by eliminating the one or more quasistatic field signals which are out of predefined operating range. Subsequently, the method includes receiving, by the receiving device, the one or more transmitted data signals based on the performed filtration. Finally, the method includes outputting, by the receiving device, the one or more received data signals to an output panel of the one or more connected devices.

Yet another aspect of the present disclosure provides a non-transitory computer-readable medium comprising machine-readable instructions that are executable by a processor to perform the method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF ACCOMPANYING DRAWINGS

The disclosure will be described and explained with additional specificity and detail with the accompanying figures in which:

FIG. 1A illustrates an exemplary representation of different modes of performing the quasistatic electromagnetic field communication through a chassis body of one or more connected devices, in accordance with an embodiment of the present disclosure;

FIG. 1B illustrates an exemplary environment for performing the quasistatic electromagnetic field communication through a chassis body of one or more connected devices, in accordance with an embodiment of the present disclosure;

FIG. 2 illustrates a detailed internal block diagram of a transmitting power source, as shown in FIG. 1B, for transmitting one or more data signals, in accordance with an embodiment of the present disclosure;

FIG. 3 illustrates a detailed block diagram of a receiving device, as shown in FIG. 1B, for receiving one or more data signals transmitted from the transmitting power source, in accordance with an embodiment of the present disclosure;

FIG. 4 illustrates an environment showing a representation of excitation of the chassis body based on transmission of the one or more data signals by transmitting power source, in accordance with an embodiment of the present disclosure;

FIG. 5 illustrates an example graphical representation of increasing the maximum power of the one or more transmitted data signals or the receiving device, through optimization of one or more optimizable transmitter or receiver electrodes, in accordance with an embodiment of the present disclosure;

FIG. 6A illustrates a schematic representation of optimization of one or more optimizable transmitter electrodes and capacitive coupling of the one or more optimizable transmitter electrodes with the chassis body of the connected device, in accordance with an embodiment of the present disclosure;

FIG. 6B illustrates a schematic representation of optimization of one or more optimizable receiver electrodes and capacitive coupling of the one or more optimizable receiver electrodes with the chassis body of the connected device, in accordance with an embodiment of the present disclosure;

FIG. 7 illustrates an example graphical representation of influence of optimization one or more optimizable transmitter electrodes and optimizable receiver electrodes, on the loss value of one or more transmitted data signals, in accordance with an embodiment of the present disclosure;

FIG. 8 illustrates a schematic diagram of placing of one or more transformers around the one or more inductors connected to the transmitting power source to increase the voltage of the one or more data signals transmitted from the transmitting power source, in accordance with an embodiment of the present disclosure;

FIG. 9 illustrates a representation of AC-DC converter, coupled with the one or more optimizable receiver electrodes for converting the one or more AC data signals to DC power signals, in accordance with an embodiment of the present disclosure;

FIG. 10 illustrates a schematic representation of the coupling of one or more filters with the receiving device, in accordance with an embodiment of the present disclosure;

FIGS. 11A-11B shows an exemplary graphical representation of influence of the filter on the interference of the one or more data signals, in accordance with an embodiment of the present disclosure;

FIG. 12 illustrates an example graphical representation of influence of shape and size of the one or more optimizable transmitter electrodes and the one or more optimizable receiver electrodes on the link margin value, in accordance with an embodiment of the present disclosure;

FIG. 13 illustrates a flow chart representation of method for performing the quasistatic electromagnetic field communication using the chassis body of one or more connected devices, in accordance with an embodiment of the present disclosure;

FIG. 14 illustrates a flowchart representation of method for performing the excitation of the chassis body based on the transmitted one or more data signals, in accordance with an embodiment of the present disclosure; and

FIG. 15 illustrates an exemplary computer system for performing quasistatic electromagnetic field communication using the chassis body of one or more connected devices, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For simplicity and illustrative purposes, the present disclosure is described by referring mainly to examples thereof. The examples of the present disclosure described herein may be used together in different combinations. In the following description, details are set forth in order to provide an understanding of the present disclosure. It will be readily apparent, however, that the present disclosure may be practiced without limitation to all these details. Also, throughout the present disclosure, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being performed or considered.

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration”. Any embodiment or implementation of the present subject matter described herein as “exemplary” is not necessarily to be construed as preferred or advantageous over other embodiments. The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment”, “in an exemplary embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting. A computer system (standalone, client, or server, or computer-implemented system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or a “subsystem” may also comprise programmable logic or circuitry (as encompassed within a general-purpose processor or other programmable processor) that is temporarily configured by software to perform certain operations. Accordingly, the term “module” or “subsystem” should be understood to encompass a tangible entity, be that an entity that is physically constructed permanently configured (hardwired), or temporarily configured (programmed) to operate in a certain manner and/or to perform certain operations described herein.

Embodiments described herein provide a quasistatic electromagnetic field communication system and method for performing the quasistatic electromagnetic field communication using a chassis body of one or more devices connected to the system. The present system uses the chassis body of the one or more connected devices as a communicating medium for transferring one or more data signals. The use of the chassis body as the communicating medium is used to reduce the channel loss during the transmission of one or more data signals from the transmitting power source. Further, at the receiving device end, the use of optimizable receiver electrodes leads to increasing efficiency of received one or more data signals. Further, higher power delivery is also possible due to the transmitting power source being capacitively coupled with the chassis body of the one or more connected devices, by grounding the one or more optimizable transmitter electrodes to the chassis body of the one or more connected devices. The proposed methodology may mitigate interference caused due to reception of multiple signals at the receiving device. Further, the present method also allows the dependency of the system on wireless communication such as Bluetooth or Wi-Fi, and wired communication when communicating with one or more connected devices.

In an embodiment, the quasistatic electromagnetic field communication system comprises a transmitting power source comprising one or more optimizable transmitter electrodes, capacitively coupled with the chassis body of the one or more connected devices. The transmitting power source may be configured to transmit one or more data signals to the one or more connected devices through the chassis body associated with the one or more connected devices. Further the transmitting power source may be configured to perform excitation of the chassis body based on the transmission.

In an embodiment, the quasistatic electromagnetic field communication system comprises the chassis body which further comprises a conducting medium. Further in an embodiment, the conducting medium of the chassis body is utilized to create one or more quasistatic field signals upon the excitation of the chassis body.

Furthermore, in an embodiment, the quasistatic electromagnetic field communication system comprises a receiving device which further comprises one or more optimizable receiver electrodes and one or more filters. The one or more optimizable receiver electrodes may be capacitively coupled with the chassis body and an output panel of the one or more connected devices, and the one or more filters may be coupled with the one or more optimizable receiver electrodes associated with the receiving device.

In an embodiment, the receiving device may be configured to receive the one or more quasistatic field signals from the chassis body. Further the receiving device may be configured to perform filtration of the received one or more quasistatic field signals by eliminating the one or more quasistatic field signals which are out of predefined operating range. Subsequently, the receiving device may be configured to receive the one or more transmitted data signals based on the performed filtration. Finally, the receiving device may be configured to output the received one or more signals to the output panel of the one or more connected devices.

The present disclosure discloses a near-field quasistatic communication system for displays. The system utilizes specially shaped electrodes in a transmitter and receiver placed near the TV or a display. The transmitter excites the electrodes with an AC signal, potentially at the chassis' resonant frequency. This excitation spreads a quasistatic signal on the TV body through the chassis. The receiver electrodes collect signals, and a filter is used to eliminate any potential interferences from internal TV circuits. This low-power, high-efficiency system operates within regulations and is unaffected by EMI from TVs. The confinement of the signal on the TV body also enables physically secure communication at a much lower power compared to wireless links. This invention is a method for wireless communication within the chassis of a TV, a monitor, or any display device. By using electric field, the communication signal is mostly limited within the proximity of the TV, minimizing any signal leakage or propagation of the signal. The transmitter and the receiver in this method are placed around the body of the TV to establish communication between peripheral devices. Utilizing advanced networking protocol allows multiple devices to exchange information.

Confining the signal to the proximity of the TV also minimizes eavesdropping security threats. Additionally, minimizing the radiated power reduces the overall power consumption, increasing the effective energy per bit of the transmission

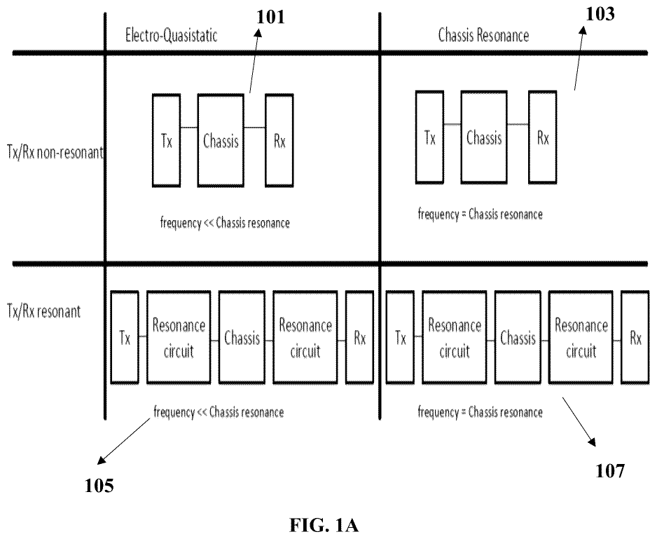

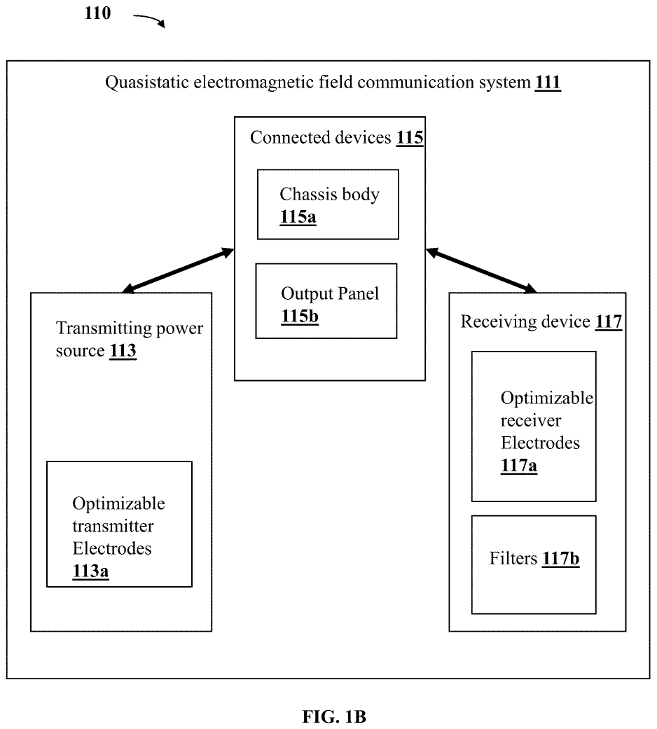

Referring now to the drawings, and more particularly to FIG. 1A through FIG. 15, where reference characters denote corresponding features consistently throughout the figures, there are shown preferred embodiments, and these embodiments are described in the context of the following exemplary system and/or method.

FIG. 1A illustrates an exemplary representation of different modes of performing the quasistatic electromagnetic field communication through a chassis body of one or more connected devices, in accordance with an embodiment of the present disclosure.

FIG. 1A illustrates a system for implementing four distinct modes of chassis-based communication, each mode depicting different states of resonance and frequency alignment between the chassis and electrodes. The figure is divided into four quadrants, representing specific configurations as follows:

Top Left Quadrant: This mode 101 represents an Electro-quasistatic (EQS) communication mode with non-resonant electrodes, where the driving electrodes are configured without resonant components, and the operating frequency is set below the natural resonance frequency of the chassis. In this configuration, the electrodes function in a non-resonant state relative to the chassis. In an embodiment, as shown in block 101, the one or more optimizable transmitter electrodes may be driven without any resonant components and the frequency of the one or more transmitted signals may be below the resonance of the chassis body of the one or more connected devices.

Bottom Left Quadrant: This mode 105 illustrates an EQS communication mode with resonant electrodes, where the electrodes are driven at their resonance frequency. However, the operating frequency remains below the chassis resonance. In this setup, only the electrodes are resonant, while the chassis operates below its resonance threshold. Furthermore, in an embodiment, as shown in block 105, the one or more optimizable transmitter electrodes may be driven with resonant components and the frequency of the one or more transmitted signals may be below the resonance of the chassis body of the one or more connected devices.

Top Right Quadrant: This configuration 103 shows a Chassis resonance mode with non-resonant electrodes, where the chassis is driven at its resonance frequency while the electrodes do not resonate. In this mode, the chassis alone is in resonance, providing the primary basis for signal transmission, while the electrodes are driven at a non-resonant frequency. Further in an embodiment, as shown in block 103, the one or more optimizable transmitter electrodes may be driven without any resonant components and the frequency of the one or more transmitted signals may be equal to the resonance of the chassis body of the one or more connected devices.

Bottom Right Quadrant: This final configuration 107 depicts a Resonant communication mode involving both the chassis and electrodes, where both the chassis and the electrodes are simultaneously driven at their respective resonance frequencies. This dual resonance mode enables maximal signal propagation within the system by leveraging both resonant components. Further in an embodiment, as shown in block 107, the one or more optimizable transmitter electrodes may be driven with resonant components and the frequency of the one or more transmitted signals may be equal to the resonance of the chassis body of the one or more connected devices.

Each quadrant illustrates the unique alignment of frequency and resonance conditions for the electrodes and chassis, providing varied operational modes for effective chassis-based communication across different configurations.

FIG. 1B illustrates an exemplary environment 110 for performing the quasistatic electromagnetic field communication through a chassis body 115a of one or more connected devices 115, in accordance with an embodiment of the present disclosure. As illustrated in FIG. 1B, the environment 110 may include a quasistatic electromagnetic field communication system 111, which further includes a transmitting power source 113, one or more connected devices 115, and a receiving device 117. The transmitting power source 113 may include, without limiting to, one or more optimizable transmitter electrodes 113a. In an embodiment, the one or more optimizable transmitter electrodes 113a may correspond to one or more transmitter electrodes that may be optimized to different dimensions and orientations with respect to the transmitting power source 113. Further in an embodiment, the one or more optimizable transmitter electrodes 113a may correspond to one or more electrodes which may be optimized by the designer or any other equivalent automated tool, during the design stage of the one or more electrodes.

Further, in an embodiment, the transmitting power source 113 may include, without limiting to, any device which may transmit one or more data signals such as a camera system, a display system, or a remote mobile and the like. The one or more optimizable transmitter electrodes 113a may be capacitively coupled with the chassis body 115a of the one or more connected devices 115. In an embodiment, the transmitting power source 113 may be configured to transmit one or more data signals to the one or more connected devices 115 through the chassis body 115a associated with the one or more connected devices 115. In an embodiment, the one or more transmitted data signals may include at least video signals, audio signals, light signals and sensor signals. Further, the transmitting power source 113 may be configured to perform excitation of the chassis body 115a based on the transmission.

Further, in an example embodiment, the one or more connected devices system 115 may include, without limiting to, a chassis body 115a and an output panel 115b. The chassis body 115a may further include a conducting medium, in which the conducting medium of the chassis body 115a is configured to create one or more quasistatic field signals upon the excitation of the chassis body 115a. In an embodiment, the chassis body 115a may include, without limiting to, a metal body, a semiconductor body, or a metal sheet. In an embodiment, the chassis body 115a itself acts as the conducting medium.

Furthermore, in an example embodiment, the receiving device 117 may include, without limiting to, one or more optimizable receiver electrodes 117a and one or more filters 117b. The one or more optimizable receiver electrodes 117a may be capacitively coupled with the chassis body 115a and the output panel 115b of the one or more connected devices 115. In an embodiment, the one or more optimizable receiver electrodes 117a may correspond to one or more receiver electrodes that may be optimized to different dimensions and orientations with respect to the receiving device 117. In an embodiment, size of the one or more optimizable receiver electrodes 117a associated with the receiving device 117 is directly proportional to the power of the received data signals at receiving device 117. Further the one or more filters 117b may be coupled with the one or more optimizable receiver electrodes 117a associated with the receiving device 117.

In an embodiment, the receiving device 117 may be configured to receive the one or more quasistatic field signals from the chassis body 115a. Further, the receiving device 117 may be configured to perform filtration of the received one or more quasistatic field signals by eliminating the one or more quasistatic field signals which are out of predefined operating range. Furthermore, the receiving device 117 may be configured to receive the one or more transmitted data signals based on the performed filtration. Finally, the receiving device 117 may be configured to output the received one or more signals to the output panel 115b of the one or more connected devices 115.

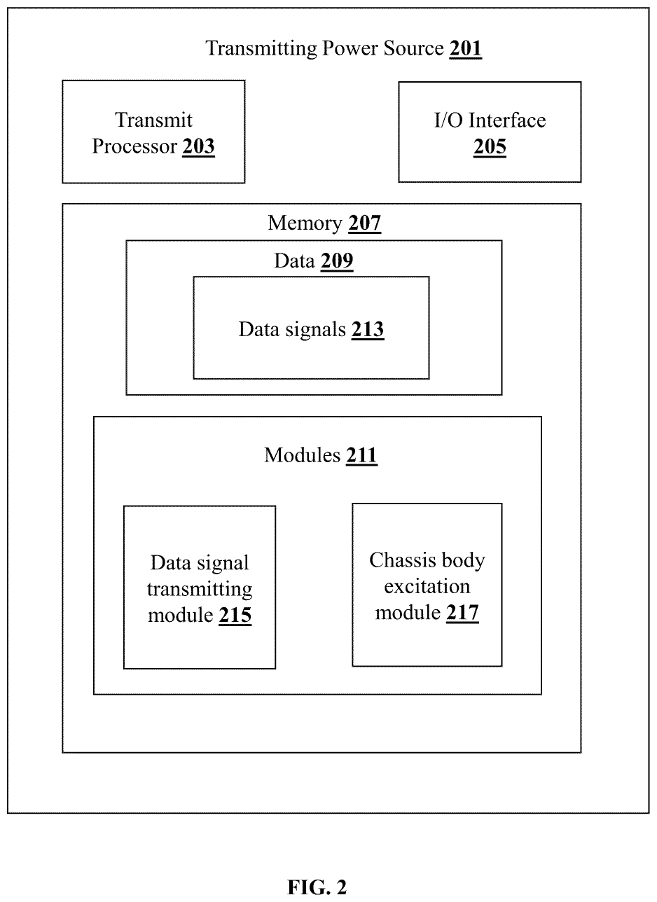

FIG. 2 illustrates a detailed internal block diagram of a transmitting power source 201, as shown in FIG. 1B, for transmitting one or more data signals, in accordance with an embodiment of the present disclosure. In an embodiment, the transmitting power source 201 is similar to transmitting power source 113 of FIG. 1B. The transmitting power source 201 may include, without limiting to, a transmit processor 203, an I/O interface 205, and a memory 207 storing instructions, executable by the transmit processor 203, which, on execution, may cause the transmitting power source 201 to transmit the one or more data signals. In an embodiment, the memory 207 may include data 209 and one or more modules 211. In an embodiment, each of the one or more modules 211 may be a hardware unit which may be outside the memory 207 and coupled with the transmitting power source 201. In an embodiment, the data 209 may include for example, one or more data signals 213. Further in an embodiment, the one or more modules 211 may include a data signal transmitting module 215, and a chassis body excitation module 217.

In an embodiment, the data signal transmitting module 215 may be configured to transmit one or more data signals 213 to the one or more connected devices 115 through the chassis body 115a associated with the one or more connected devices 115.

Further in an embodiment, the chassis body excitation module 217 may be configured to perform excitation of the chassis body 115a based on the transmission. This is performed by determining a resonance of the chassis body 115a and performing boosting of the one or more transmitted data signals 213 through the resonance of the chassis body 115a, which is in turn performed by incorporating one or more inductors in series with the one or more optimizable transmitter electrodes 113a associated with the transmitting power source 201. Finally, the chassis excitation module 217 transmits the one or more boosted data signals 213 to the chassis body 115a. In other words, this is performed to confine the one or more data signals 213 within the proximity of the one or more connected devices 115 for preventing loss of one or more data signals 213 into surrounding environments. In an embodiment, the one or more data signals 213 may be confined to the chassis body 115a when resonance of the one or more transmitted data signals 213 are boosted to the determined resonance of the chassis body 115a.

Further, in an embodiment, the chassis body 115a may further include a conducting medium, in which the conducting medium of the chassis body 115a is configured to create one or more quasistatic field signals upon the excitation of the chassis body 115a. The one or more quasistatic field signals may be created around the chassis body 115a due to the voltage difference between the one or more optimizable transmitter electrodes 113a.

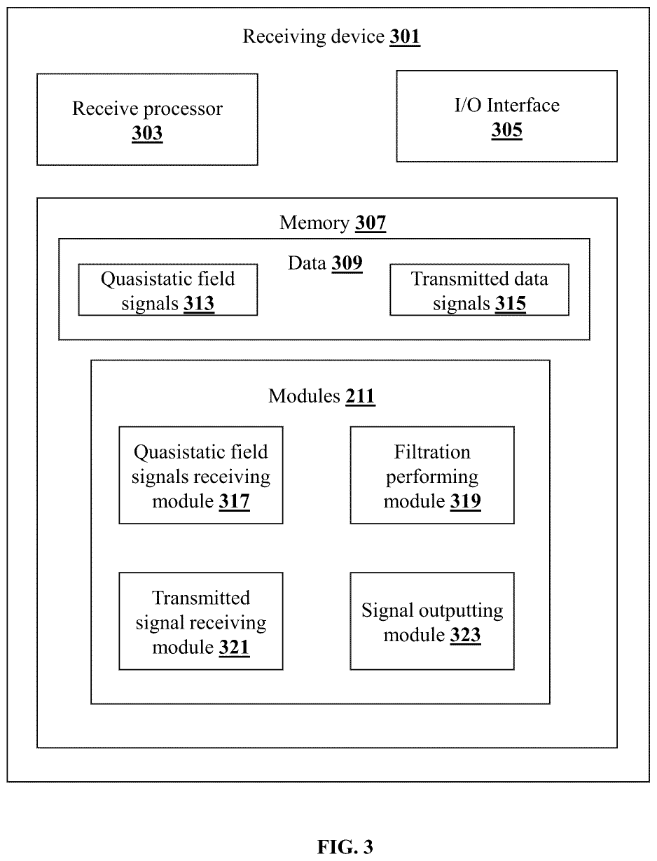

FIG. 3 illustrates a detailed block diagram of a receiving device 301, as shown in FIG. 1B, for receiving one or more data signals 213 transmitted from the transmitting power source 201, in accordance with an embodiment of the present disclosure.

In an embodiment, the receiving device 301 is similar to receiving device 117 of FIG. 1B. The receiving device 301 may include, without limiting to, a receive processor 303, an I/O interface 305, and a memory 307 storing instructions, executable by the receive processor 303, which, on execution, may cause the receiving device 301 to receive the one or more data signals 213 transmitted from the transmitting power source 201. In an embodiment, the memory 307 may include data 309 and one or more modules 311. In an embodiment, each of the one or more modules 311 may be a hardware unit which may be outside the memory 307 and coupled with the receiving device 301. In an embodiment, the data 309 may include for example, one or more quasistatic field signals 313 and one or more transmitted data signals 315. In an embodiment, the one or more transmitted data signals 315 is similar to the one or more data signals 213 of FIG. 2. Further in an embodiment, the one or more modules 311 may include a quasistatic field signal receiving module 317, a filtration performing module 319, a transmitted signal receiving module 321, a signal outputting module 323.

In an embodiment, the quasistatic field signal receiving module 317 may be configured to receive the one or more quasistatic field signals 313 from the chassis body 115a.

In an embodiment, the filtration performing module 319 may be configured to perform filtration of the received one or more quasistatic field signals 313. This is performed by eliminating the one or more quasistatic field signals 313 which are out of predefined operating range.

In an embodiment, the transmitted signal receiving module 321 may be configured to receive the one or more transmitted data signals 315 based on the performed filtration. Further in an embodiment, the signal outputting module 323 may be configured to output the received one or more signals 315 to the output panel 115b of the one or more connected devices 115 after being processed or demodulated.

Further, the receiving device 301 may include, without limiting to, one or more optimizable receiver electrodes 117a and one or more filters 117b (as illustrated in FIG. 1B). The one or more optimizable receiver electrodes 117a may be capacitively coupled with the chassis body 115a and the output panel 115b of the one or more connected devices 115. The capacitive coupling with the chassis body 115a of the one or more connected devices 115 may be performed by shorting one or more ground reference electrodes of the one or more optimizable receiver electrodes 117a to the chassis body 115a of the one or more connected devices 115. Further the capacitive coupling with the output panel 115b of the one or more connected devices 115 may be performed by placing one or more signal input electrodes of the one or more optimizable receiver electrodes 117a parallel to the chassis body 115a of the one or more connected devices 115.

Further the one or more filters 117b may be coupled with the one or more optimizable receiver electrodes 117a associated with the receiving device 301. In an embodiment, the one or more filters 117b may be placed between the one or more optimizable receiver electrodes 117a associated with the receiving device 301 and an input terminal of the receiving device 301.

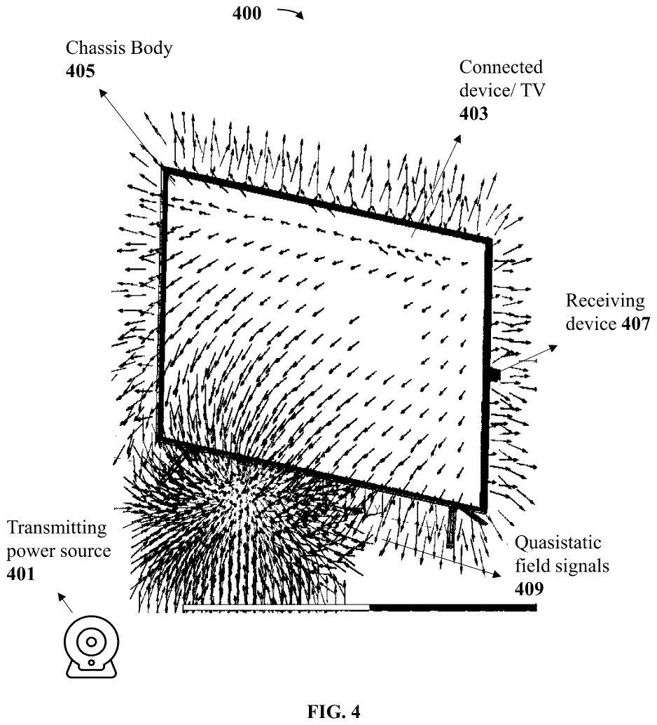

FIG. 4 illustrates an environment 400 showing a representation of excitation of the chassis body 115a based on transmission of the one or more data signals 213 by transmitting power source 113, in accordance with an embodiment of the present disclosure.

In an embodiment, the environment 400 may include, without limiting to, a transmitting power source 401, a connected device 403, a chassis body 405 associated with the connected device 403, a receiving device 407 and one or more quasistatic field signals 409. In an embodiment, the transmitting power source 401 is similar to transmitting power source 113 of FIG. 1B and 201 of FIG. 2. Further in an embodiment, the receiving device 407 is similar to receiving device 117 of FIG. 1B and 301 of FIG. 3.

Furthermore, in an example embodiment, the connected device 403, may include without limiting to, a Television (TV), a monitor, or any display device. For example, as illustrated in FIG. 4, the connected device 403 is a TV, which may include the chassis body 405 inside it. The chassis body 405 may include a conducting medium inside it which is responsible for creation of one or more quasistatic field signals 409. In an embodiment, the chassis body 405 is similar to chassis body 115a of FIG. 1B.

In an embodiment, the data signal transmitting module 215 (as shown in FIG. 2) of the transmitting power source 401 may be configured to transmit one or more data signals 213 to the TV 403 through the chassis body 405 associated with the TV 403. The one or more data signals 213 may include, without limiting to, one or more video signals, one or more audio signals, one or more light signals, and one or more sensor signals.

Further, chassis body excitation module 217 of the transmitting power source 401 may be configured to perform excitation of the chassis body 405 based on the transmission. This is performed by determining a resonance of the chassis body 405 and performing boosting of the one or more transmitted data signals 213 through the resonance of the chassis body 405, which is in turn performed by incorporating one or more inductors in series with the one or more optimizable transmitter electrodes 113a associated with the transmitting power source 401. Further, one or more transformers may be placed around the one or more inductors connected to the transmitting power source 401, in which the one or more transformers are configured to increase the voltage of the one or more data signals 213 transmitted from the transmitting power source 401. For example, the one or more transformers may include, without limiting to, a step-up transformer 801 which may increase the voltage of the one or more data signals 213 transmitted from the transmitting power source 113.

Finally, the chassis excitation module 217 transmits the one or more boosted data signals 213 to the chassis body 405. The excitation of the chassis body 405 leads to creation of electric field around the TV 403, which may be generated in a quasistatic manner. This results to creation of one or more quasistatic field signals 409 around the TV 113. In an embodiment, the voltage difference between the one or more optimizable transmitter electrodes 113a may generate the one or more quasistatic one quasistatic field signals 409 around the chassis body 115a due to the excitation of the chassis body 115a. More specifically, the conducting medium of the chassis body 405 is configured to create one or more quasistatic field signals 409 upon the excitation of the chassis body 405. In an embodiment, the one or more quasistatic field signals 409 is similar to one or more quasistatic field signals 313 of FIG. 3.

In an embodiment, the quasistatic field signal receiving module 317 of the receiving device 407 may be configured to receive the one or more quasistatic field signals 409 from the chassis body 405.

Further in an embodiment, the filtration performing module 319 of the receiving device 407 may be configured to perform filtration of the received one or more quasistatic field signals 409. This is performed by eliminating the one or more quasistatic field signals 409 which are out of predefined operating range. In an example embodiment, the filtration of the received one or more quasistatic field signals 409 by eliminating the one or more quasistatic field signals 409 which are out of predefined operating range corresponds to discarding one or more external signals transmitted from one or more external devices. This predefined operating range may be set according to the user requirements. In an embodiment, the predefined operating range may be in terms frequency band values. For example, the predefined operating range may set as 10 MHz to 20 MHz. Suppose if one or more multiple signals reach the receiving device 407 from multiple sources, the filtration performing module 319 may separate the one or more unwanted signals which are out of 10 MHz-20 MHz range. This leads to reception of only the one or more data signals 213 transmitted from the transmitting power source 401.

Furthermore, an embodiment, the transmitted signal receiving module 321 of the receiving device 407 may be configured to receive the one or more transmitted data signals 315 (also referred to as 213) based on the performed filtration. Finally, the signal outputting module 323 of the receiving device 407 may output the received one or more signals 315 to the output panel 115b of the TV 403. That is, the received one or more signals 315 may be outputted as a display on TV 115b.

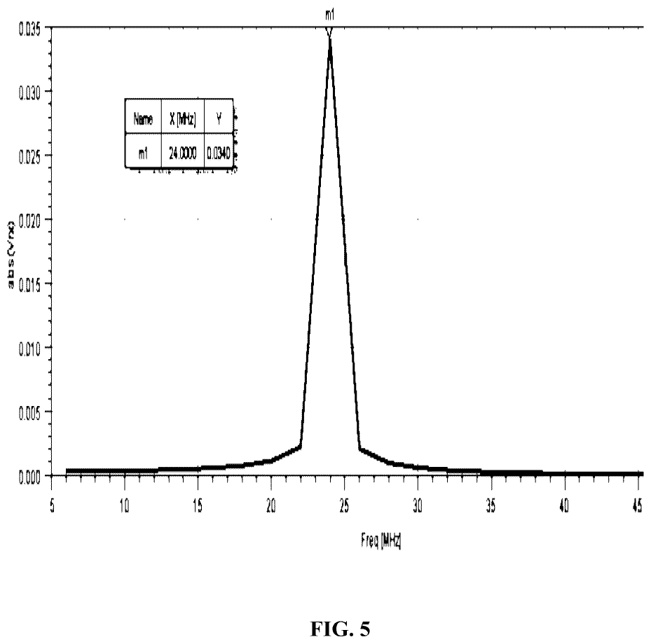

FIG. 5 illustrates an example graphical representation of increasing the maximum voltage of the received one or more transmitted data signals 315 at the receiving device 117, through optimization of one or more optimizable receiver electrodes 117a associated with the receiving device 117, in accordance with an embodiment of the present disclosure. The resonance caused by the inductor causes the voltage increase of the one or more transmitted data signals 315.

In an embodiment, the receiving device 117 is configured to optimize the one or more optimizable receiver electrodes 117a associated with it, to increase the maximum power of the received one or more transmitted data signals 213. In an embodiment, optimizing the one or more receiver electrodes may correspond to altering the dimensions and orientations of the optimizable receiver electrodes 117a with respect to the receiving device 117. In other words, the optimization of the one or more optimizable receiver electrodes 117a may be performed by increasing or decreasing the size of the one or more optimizable receiver electrodes 117a. In other words, the size of the one or more optimizable receiver electrodes 117a associated with the receiving device 117 is directly proportional to the power of the received data signals 213 at the receiving device 117. Further in an embodiment, the one or more optimizable transmitter electrodes 113a may correspond to one or more electrodes which may be optimized by the designer or any other equivalent automated tool, during the design stage of the one or more electrodes.

Further in an embodiment, the power of the received one or more data signals 213 may be maximum when the voltage of the transmitted one or more signals 213 is maximum. This is performed by transmitting power source 113, where one or more transformers are placed around the one or more inductors connected to the transmitting power source 113, such that the one or more transformers are configured to increase the voltage of the one or more data signals 213 transmitted from the transmitting power source 113. This leads to increase in the maximum power of the received one or more data signals 213 at the receiving device 117. In an embodiment, the one or more transformers may receive the one or more data signals 213 from the transmitting power source 113 and may increase the voltage of the one or more data signals 213.

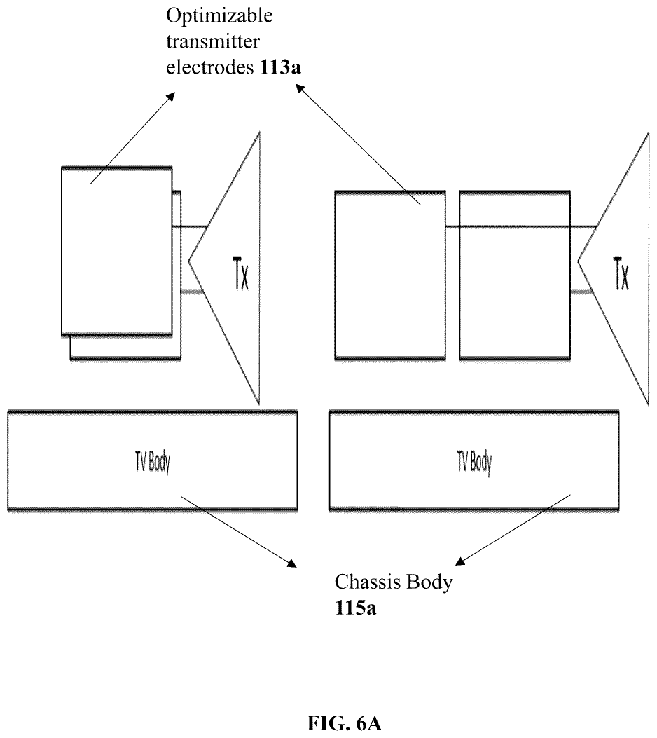

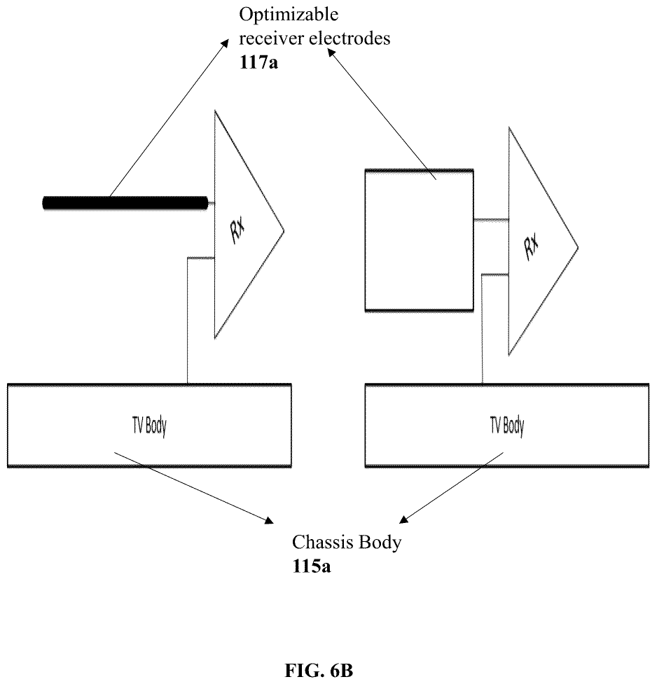

FIG. 6A illustrates a schematic representation of optimization of one or more optimizable transmitter electrodes 113a and capacitive coupling of the one or more optimizable transmitter electrodes 113a with the chassis body 115a of the connected device, in accordance with an embodiment of the present disclosure.

In an embodiment, the transmitting power source 113 may include one or more optimizable transmitter electrodes 113a having different dimensions and orientations. For example, as shown in FIG. 6A, the one or more optimizable transmitter electrodes 113a may be in the form of a planar shape, a wired shape, shape of a notch or in terms of parallel plates. In other words, the size of the one or more optimizable transmitter electrodes may be proportional to voltage of the one or more transmitted data signals 213. Further, as shown in FIG. 6A, the transmitting power source 113 may be capacitively coupled with the chassis body 115a of the one or more connected devices 115 such as TV 403. In an embodiment, the one or more optimizable transmitter electrodes 113a may be present in close proximity to the chassis body 115a. Further in an embodiment, the one or more data signals 213 may excite the one or more optimizable transmitter electrodes 113a to generate one or more fields around the one or more optimizable transmitter electrodes 113a. Further the generated one or more fields may couple with the chassis body 115a to perform the excitation of the chassis body 115a.

FIG. 6B illustrates a schematic representation of optimization of one or more optimizable receiver electrodes 117a, and capacitive coupling of the one or more optimizable receiver electrodes 117a with the chassis body 115a of the connected device, in accordance with an embodiment of the present disclosure.

In an embodiment, the receiving device 117 may include one or more optimizable receiver electrodes 117a having different dimensions and orientations. For example, as shown in FIG. 6B, the one or more optimizable receiver electrodes 117a may be in the form of a planar shape, a wired shape, shape of a notch or in terms of parallel plates. In other words, the size of the one or more optimizable receiver electrodes may be proportional to voltage and power of the one or more received data signals 213 from the transmitting power source 113. Further, as shown in FIG. 6B, the receiving device 117 may be capacitively coupled with the chassis body 115a of the one or more connected devices 115 such as TV 403. This may be performed by shorting one or more ground reference electrodes of the one or more optimizable receiver electrodes 117a to the chassis body 115a of the one or more connected devices 115

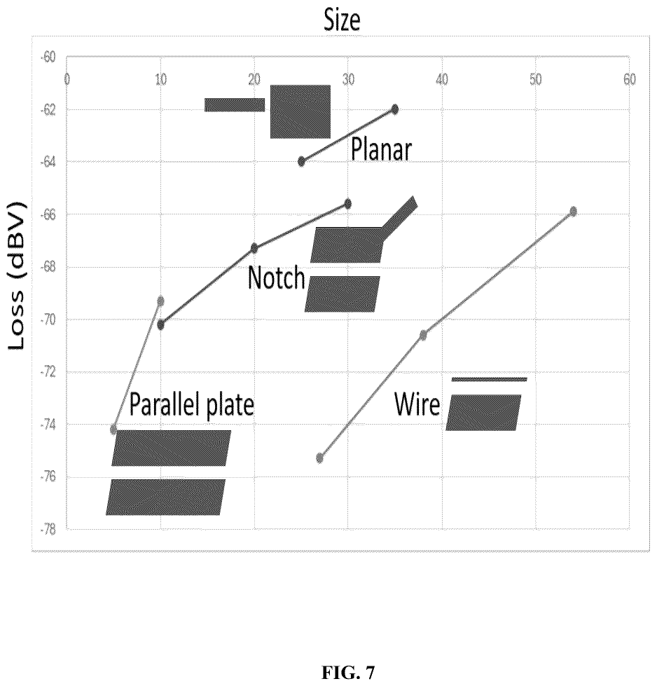

FIG. 7 illustrates an example graphical representation of influence of optimization one or more optimizable transmitter electrodes and optimizable receiver electrodes, on the loss value of one or more transmitted data signals, in accordance with an embodiment of the present disclosure.

In an embodiment, the one or more optimizable transmitter electrodes 113a and optimizable receiver electrodes 117a may be in the form of a planar shape, a wired shape, shape of a notch or in terms of parallel plates. The loss value is directly proportional to the shape and size of the one or more optimizable transmitter electrodes 113a and optimizable receiver electrodes 117a. In an embodiment, the loss value corresponds to amount of loss of one or more data signals 213 that are transmitted from the transmitting power source 113a.

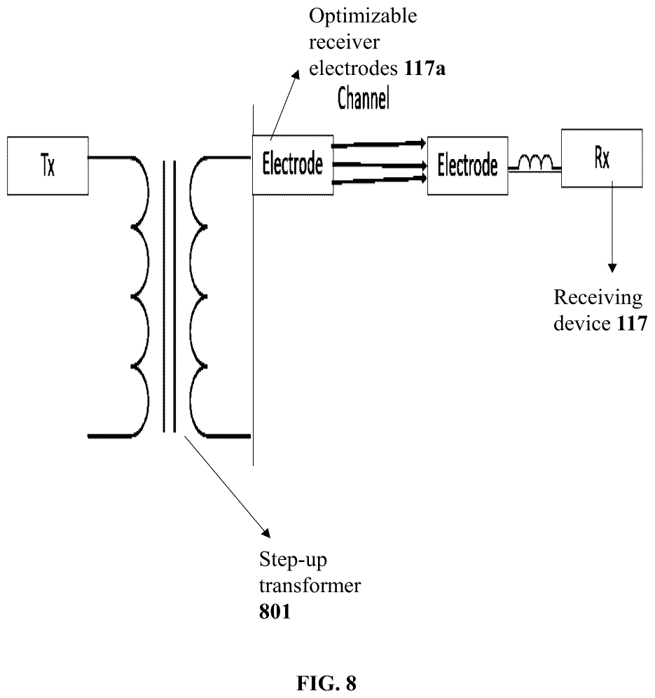

FIG. 8 illustrates a schematic diagram of placing of one or more transformers around the one or more inductors connected to the transmitting power source 113 to increase the voltage of the one or more data signals 213 transmitted from the transmitting power source 113, in accordance with an embodiment of the present disclosure.

In an embodiment, the one or more transformers may include, without limiting to, a step-up transformer 801 which may increase the voltage of the one or more data signals 213 transmitted from the transmitting power source 113. As shown in FIG. 8, a transformer is placed around the one or more inductors by coupling the transformer with the one or more optimizable transmitter electrodes 113a . . . . In an embodiment, the one or more transformers may receive the one or more data signals 213 from the transmitting power source 113 and may increase the voltage of the one or more data signals 213.

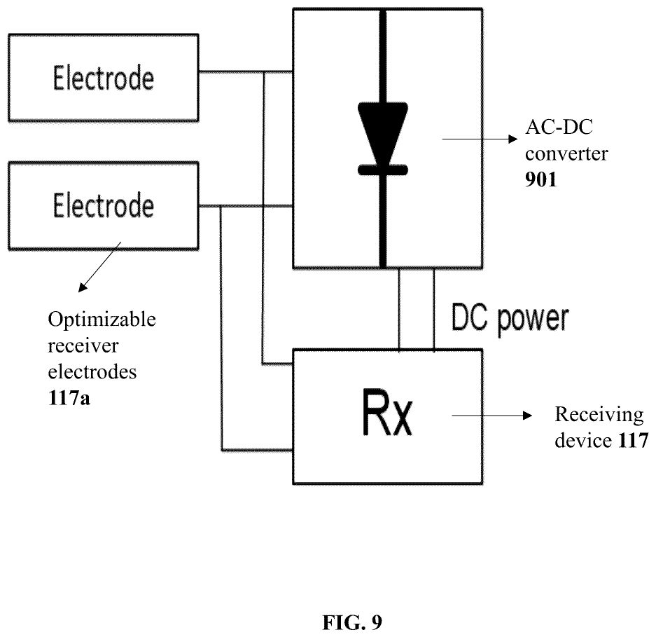

FIG. 9 illustrates a representation of an AC-DC converter 901, coupled with the one or more optimizable receiver electrodes 117a for converting the one or more AC data signals to DC data signals, in accordance with an embodiment of the present disclosure.

In an embodiment, the one or more data signals 213 transmitted from the transmitting power source and the one or more quasistatic field signals 313 generated in the chassis body 115a may be in Alternating Current (AC) form. In an embodiment, as shown in FIG. 9, the AC-DC converter 901 may be coupled with the one or more optimizable receiver electrodes 117a through an electrical connection, for converting the one or more AC data signals 213 into the one or more DC power signals 213 to power the receiving device.

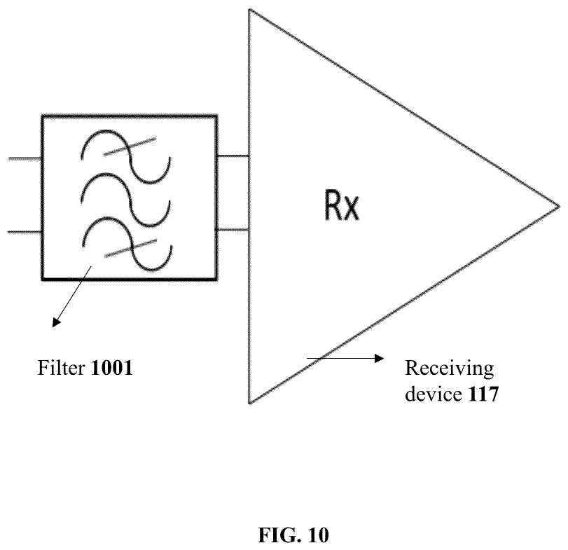

FIG. 10 illustrates a schematic representation of the coupling of a filter 1111 with the receiving device 117, in accordance with an embodiment of the present disclosure.

In an embodiment, the filter 1111 is similar to the one or more filters 117b of FIG. 1B. The one or more filters 117b may be placed between the one or more optimizable receiver electrodes 117a associated with the receiving device 117 and an input terminal of the receiving device 117. Further in an embodiment, the filter 1111 may include, without limiting to, a Band Pass Filter (BPF).

In an embodiment, the filter 1111 may be configured to perform filtration of the received one or more quasistatic field signals 313. This is performed by eliminating the one or more quasistatic field signals 313 which are out of predefined operating range. In an embodiment, the predefined operating range may be in terms frequency band values. For example, the predefined operating range may set as 10 MHz to 20 MHz. Suppose if one or more multiple signals reach the receiving device 117 from multiple sources, the filter 1111 may separate the one or more unwanted signals which are out of 10 MHz-20 MHz range. This leads to reception of only the one or more data signals 213 transmitted from the transmitting power source 113.

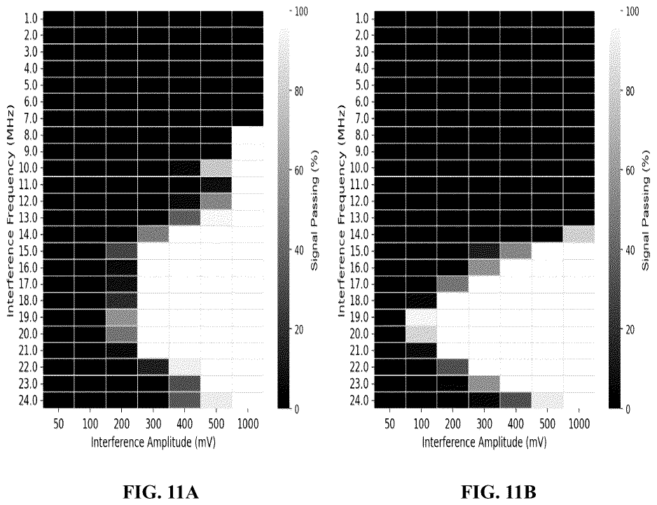

FIGS. 11A-11B shows an exemplary graphical representation of influence of the filter on the interference of the one or more data signals, in accordance with an embodiment of the present disclosure.

In an embodiment, as shown in FIG. 11A, when the filter 1111 is not coupled with the receiving device 117, the interference caused due to one or more data signals 213 may be high due to reception of multiple signals at the receiving device 117 end. Further, in an embodiment, as shown in FIG. 11B, when the filter 1111 is coupled with the receiving device 117, the interference caused due to one or more data signals 213 may be low due to filtration of the received one or more quasistatic field signals 313. This is performed by eliminating the one or more quasistatic field signals 313 which are out of predefined operating range.

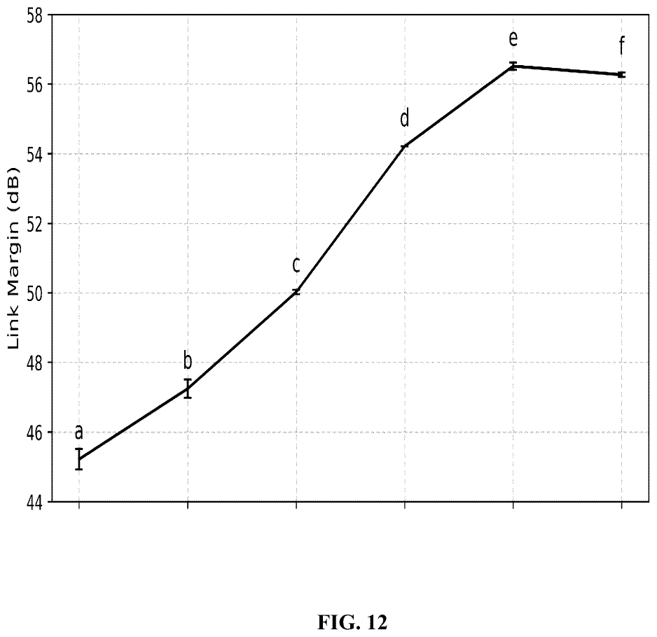

FIG. 12 illustrates an example graphical representation of influence of shape and size of the one or more optimizable transmitter electrodes 113a and the one or more optimizable receiver electrodes 117a on the link margin value, in accordance with an embodiment of the present disclosure.

In an embodiment, the one or more optimizable transmitter electrodes 113a and optimizable receiver electrodes 117a may be in the form of a planar shape, a wired shape, shape of a notch or in terms of parallel plates. The link margin is directly proportional to the shape and size of the one or more optimizable transmitter electrodes 113a and optimizable receiver electrodes 117a. In an embodiment, the link margin may correspond to efficiency of the one or more data signals 213 that are transmitted from the transmitting power source 113a. For example, as shown in FIG. 12, the link margin value is maximum for type-f electrode, and is minimum for type-a electrode. This is due to the fact that the size of the type-f electrode is larger than type-a electrode in terms of its dimensions (as shown in the below table. 1). Therefore, the link margin value varies upon the shape and size of the one or more optimizable transmitter electrodes 113a and optimizable receiver electrodes 117a.

TABLE 1

| | Dimension | | |
|---|---|---|---|
| Type | (mm × mm) | Link Margin (dB) | Standard Deviation (dB) |
| a | 1.5 × 2.0 | 45.22 | 0.3 |
| b | 2.5 × 2.0 | 47.24 | 0.27 |
| c | 3.5 × 2.5 | 50.02 | 0.07 |
| d | 7.5 × 2.5 | 54.21 | 0.0 |
| e | 7.5 × 5.0 | 56.51 | 0.11 |
| f | 8.0 × 3.8 | 56.27 | 0.06 |

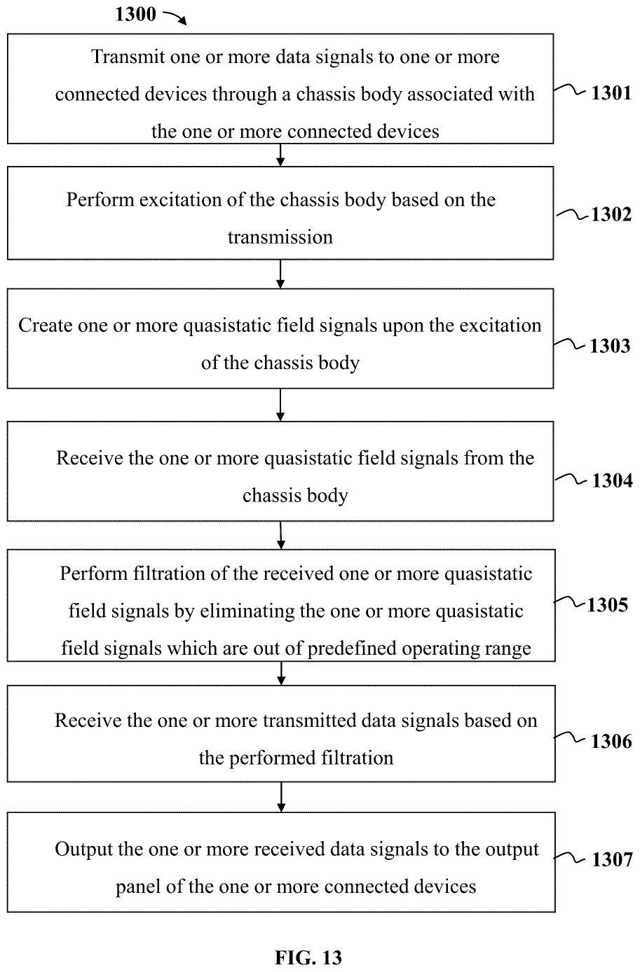

FIG. 13 illustrates a flow chart representation of method 1300 for performing the quasistatic electromagnetic field communication using the chassis body 115a of one or more connected devices 115, in accordance with an embodiment of the present disclosure.

At step 1301, the method 1300 includes transmitting, by a transmitting power source 113, one or more data signals 213 to one or more connected devices 115 through the chassis body 115a associated with the one or more connected devices 115. In an embodiment, the one or more transmitted data signals 213 may include at least video signals, audio signals, light signals and sensor signals.

At step 1302, the method 1300 includes performing, by the transmitting power source 113, excitation of the chassis body 115a based on the transmission. This is performed by determining a resonance of the chassis body 115a and performing boosting of the of the one or more transmitted data signals 213 through the resonance of the chassis body 115a, which is in turn performed by incorporating one or more inductors in series with the one or more optimizable transmitter electrodes 113a associated with the transmitting power source 113. Finally, the transmitting power source 113 transmits the one or more boosted data signals 213 to the chassis body 115a.

At step 1303, the method 1300 includes creating, by the chassis body 115a, one or more quasistatic field signals 313 upon the excitation of the chassis body 115a.

At step 1304, the method 1300 includes receiving, by a receiving device 117, the one or more quasistatic field signals 313 from the chassis body 115a. In an embodiment, the quasistatic field signal receiving module 317 of the receiving device 117 may be configured to receive the one or more quasistatic field signals 313 from the chassis body 115a.

At step 1305, the method 1300 includes performing, by the receiving device 117, filtration of the received one or more quasistatic field signals 313 by eliminating the one or more quasistatic field signals 313 which are out of predefined operating range. In an embodiment, the filtration performing module 319 of the receiving device 117 may be configured to perform filtration of the received one or more quasistatic field signals 313. This is performed by eliminating the one or more quasistatic field signals 313 which are out of predefined operating range.

At step 1306, the method 1300 includes receiving, by the receiving device 117, the one or more transmitted data signals 213 based on the performed filtration. In an embodiment, the transmitted signal receiving module 321 of the receiving device 117 may be configured to receive the one or more transmitted data signals 315 (also referred to as 213) based on the performed filtration.

At step 1307, the method 1300 includes outputting, by the receiving device 117, the one or more received data signals 213 to the output panel 115b of the one or more connected devices 115. In an embodiment, the signal outputting module 323 of the receiving device 117 may be configured to output the received one or more signals 315 to the output panel 115b of the one or more connected devices 115.

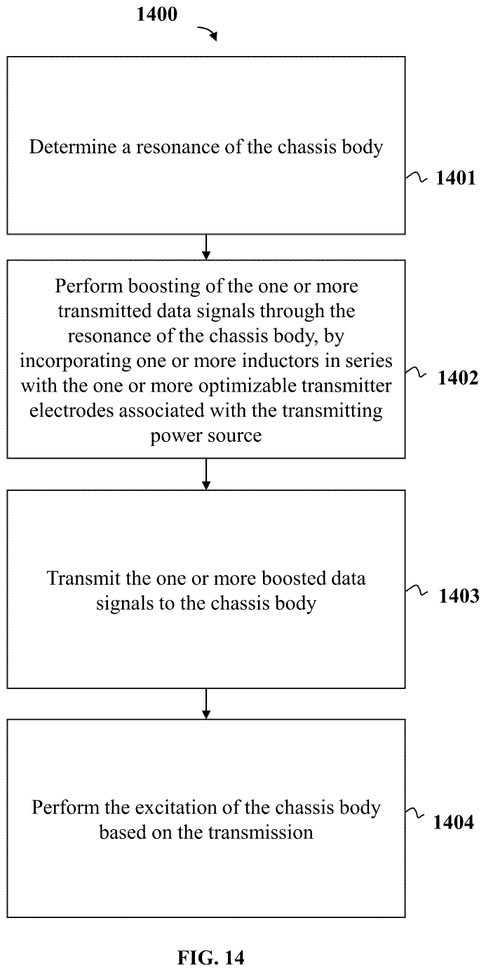

FIG. 14 illustrates a flowchart representation of method 1400 for performing the excitation of the chassis body 115a based on the transmitted one or more data signals 213, in accordance with a resonant-based embodiment of the present disclosure.

At step 1401, the method 1400 includes determining, by the transmitting power source 113, a resonance of the chassis body 115a.

At step 1402, the method 1400 includes performing, by the transmitting power source 113, boosting of the one or more transmitted data signals 315 (also referred to as 213) through the resonance of the chassis body 115a, by incorporating one or more inductors in series with the one or more optimizable transmitter electrodes 113a associated with the transmitting power source 113.

At step 1403, the method 1400 includes transmitting, by the transmitting power source 113, the one or more boosted data signals 213 to the chassis body 115a.

At step 1404, the method 14000 includes performing, by the transmitting power source 113, the excitation of the chassis body 115a based on the transmission.

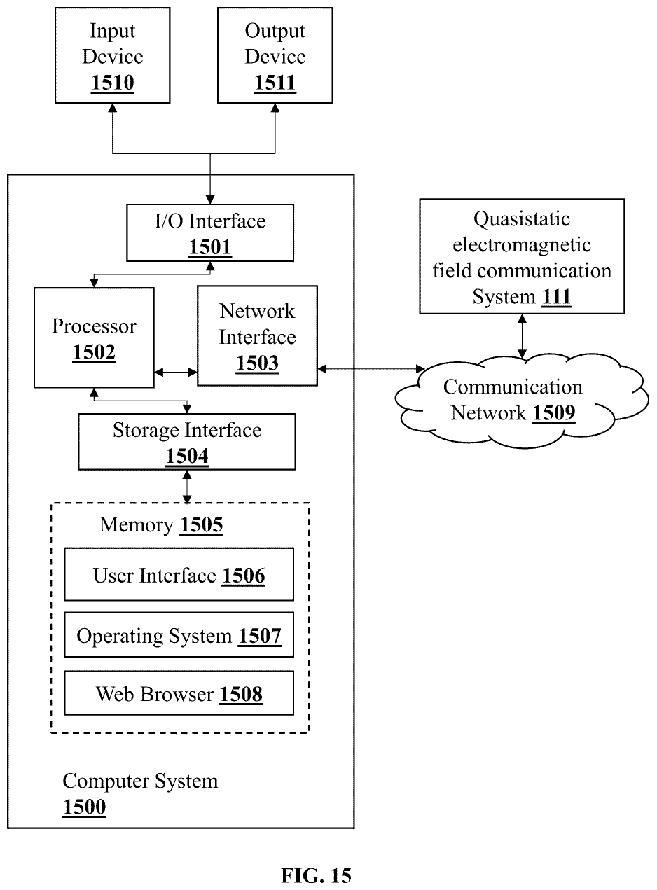

FIG. 15 shows a general-purpose computer system implementing the quasistatic electromagnetic field communication system 111 for performing the quasistatic electromagnetic field communication using a chassis body 115a of one or more devices 115 connected to the quasistatic electromagnetic field communication system 111, in accordance with embodiments of the present disclosure. In an embodiment, the computer system 1500 may be used to implement the method of performing the quasistatic electromagnetic field communication using the chassis body 115a of one or more connected devices 115. The computer system 1500 may comprise a central processing unit (“CPU” or “processor”) 1502. The processor 1502 may comprise at least one data processor for executing program components for dynamic resource allocation at run time. The processor 1502 may include specialized processing units such as integrated system bus controllers, memory management control units, floating point units, graphics processing units, digital signal processing units, and the like.

The processor 1502 may be disposed in communication with one or more input/output (I/O) devices (not shown) via I/O interface 1501. The I/O interface 1501 may employ communication protocols/methods such as, without limitation, audio, analog, digital, monoaural, RCA, stereo, IEEE-(1394), serial bus, universal serial bus (USB), infrared, PS/2, BNC, coaxial, component, composite, digital visual interface (DVI), high-definition multimedia interface (HDMI), RF antennas, S-Video, VGA, IEEE 802, Bluetooth, cellular (e.g., code division multiple access (CDMA), high-speed packet access (HSPA+), global system for mobile communications (GSM), long-term evolution (LTE), WiMax, or the like), and the like.

Using the I/O interface 1501, the computer system 1500 may communicate with one or more I/O devices. For example, the input device 1510 may be an antenna, keyboard, mouse, joystick, (infrared) remote control, camera, card reader, fax machine, dongle, biometric reader, microphone, touch screen, touchpad, trackball, stylus, smayner, storage device, transceiver, video device/source, and the like. The output device 1511 may be a printer, fax machine, video display (e.g., cathode ray tube (CRT), liquid crystal display (LCD), light-emitting diode (LED), plasma, Plasma display panel (PDP), Organic light-emitting diode display (OLED) or the like), audio speaker, and the like.

In some embodiments, the computer system 1500 is connected to the quasistatic electromagnetic field communication system 111 through a communication network 1509. The processor 1502 may be disposed in communication with the communication network 1509 via a network interface 1503. The network interface 1503 may communicate with the communication network 1509. The network interface 1503 may employ connection protocols including, without limitation, direct connect, Ethernet (e.g., twisted pair 10/110/1100 Base T), transmission control protocol/Internet protocol (TCP/IP), token ring, IEEE 802.11a/b/g/n/x, and the like. The communication network 1509 may include, without limitation, a direct interconnection, e-commerce network, a peer to peer (P2P) network, local area network (LAN), wide area network (WAN), wireless network (e.g., using Wireless Application Protocol), the Internet, Wi-Fi, and the like. Using the network interface and the communication network 1509, the computer system 1500 may communicate with the quasistatic electromagnetic field communication system 111, In some embodiments, the processor 1502 may be disposed in communication with a memory 1505 (e.g., RAM, ROM, and the like. not shown in FIG. 15) via a storage interface 1504. The storage interface 1504 may connect to memory 1505 including, without limitation, memory drives, removable disc drives, and the like, employing connection protocols such as serial advanced technology attachment (SATA), Integrated Drive Electronics (IDE), IEEE-1394, Universal Serial Bus (USB), fiber channel, Small Computer Systems Interface (SCSI), and the like. The memory 805 drives may further include a drum, magnetic disc drive, magneto-optical drive, optical drive, Redundant Array of Independent Discs (RAID), solid-state memory devices, solid-state drives, and the like.

The memory 1505 may store a collection of program or database components, including, without limitation, user interface 1506, an operating system 1507, web browser/server 1508 and the like. In some embodiments, computer system 1500 may store user/application data, such as the data, variables, records, and the like. as described in this disclosure. Such databases may be implemented as fault-tolerant, relational, scalable, secure databases such as Oracle or Sybase.

The operating system 1507 may facilitate resource management and operation of the computer system 800. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, and the like.), LINUX® DISTRIBUTIONS (E.G., RED HAT®, UBUNTUR, KUBUNTU®, and the like.), IBMROS/2®, MICROSOFT® WINDOWS® (XPR, VISTA®/7/8, 10 and the like.), APPLE® IOS®, GOOGLE™ ANDROID™, BLACKBERRY® OS, or the like.

In some embodiments, the computer system 1500 may implement a web server 1508 stored program component. The web server 1508 may be a hypertext viewing application, such as MICROSOFT® INTERNET EXPLORER®, GOOGLE™ CHROME™, MOZILLA® FIREFOX®, APPLE® SAFARI®, and the like. Secure web browsing may be provided using Secure Hypertext Transport Protocol (HTTPS), Secure Sockets Layer (SSL), Transport Layer Security (TLS), and the like. Web browsers 808 may utilize facilities such as AJAX, DHTML, ADOBE® FLASH®, JAVASCRIPT®, JAVA®, Application Programming Interfaces (APIs), and the like. In some embodiments, the computer system 1500 may implement a mail server stored program component. The mail server may be an Internet mail server such as Microsoft Exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, and the like. The mail server may utilize communication protocols such as Internet Message Access Protocol (IMAP), Messaging Application Programming Interface (MAPI), MICROSOFT® Exchange, Post Office Protocol (POP), Simple Mail Transfer Protocol (SMTP), or the like.

Furthermore, a non-transitory computer-readable medium may be utilized in implementing embodiments consistent with the present invention. The non-transitory computer-readable medium refers to any type of physical memory 1505 on which information or data readable by a processor 1502 may be stored. Thus, non-transitory computer-readable medium may store instructions for execution by one or more processors, including instructions for causing the processors to perform steps or stages consistent with the embodiments described herein.

The invention's operation involves several carefully defined parameters to optimize secure, efficient communication. The operating frequency of the AC signal may range from, for example, but not limited to, 10 MHz to 20 MHz, potentially matching the resonant frequency of the display chassis, which generally spans from, for example, but not limited to, 500 MHz to 250 MHz depending on chassis size and design. To generate a sufficiently strong field, the voltage of the AC signal may range from, for example, but not limited to, between 1 mV and 500 mV peak-to-peak, with lower voltages (for example, but not limited to, 1-10 mV) supporting low-power communication and higher voltages (for example, but not limited to, 20-500 mV) enhancing signal strength. Electrode capacitance between the transmitter or receiver electrode and the chassis, typically range from, for example, but not limited to, 1 pF to 100 pF, influences the efficiency of coupling; larger electrodes, with surface areas range from, for example, but not limited to, 1 cm² to 100 cm², provide better contact for a stronger signal. The electrode design is often in parallel plate, side-by-side, or asymmetric shapes for optimal field confinement and coupling efficiency.

Voltage amplification is achieved with an LC resonance circuit and a transformer, where inductance values may range from, for example, but not limited to, 10 μH to 500 μH to support frequencies aligned with the chassis resonance, and transformer turn ratios vary from, for example, but not limited to, 1:2 to 1:10 for signal amplification. A bandpass filter (BPF) with a center frequency matching the operating frequency (may range from, for example, but not limited to, 10 MHz to 20 MHz) removes interference from other TV circuits, ensuring a clear communication channel. Transmitter power output is kept low, typically between, for example, but not limited to, 0.01 mW and 50 mW, to comply with regulatory limits while maintaining efficiency and security.

For autonomous operation, an energy harvesting circuit provides between, for example, but not limited to, 0.1 mW and 5 mW, which powers small sensors or data circuits. An adaptive matching network adjusts impedance may range from, for example, but not limited to, 10Ω to 1 kΩ to maintain optimal resonance with the chassis as conditions vary. Feedback sensitivity thresholds may range from, for example, but not limited to, 1% to 10% detect changes in field strength, allowing for dynamic transmitter adjustments, and signal confinement limits the quasistatic field range to within, for example, but not limited to, 1 cm to 50 cm of the TV body, minimizing risks of interception. These parameters together enable the system to balance energy efficiency, security, and communication robustness tailored to display devices.

The present disclosure discloses use of one or more inductors and one or more transformers for increasing the voltage of one or more data signals for transmission. Also, the use of one or more optimizable receiver electrodes leads to increase in maximum power received by the receiving device.

The present disclosure provides a communication system for near-field wireless communication confined to a display chassis. The system includes a display device with a metallic chassis acting as a communication medium. Further, the system may include a transmitting power source (or herein referred to as ‘transmitter’) comprising a first electrode capacitively coupled to the chassis. The transmitter excites the chassis with an alternating current (AC) signal, thereby generating a quasistatic field along the chassis. The system further includes a receiver comprising a second electrode capacitively coupled to the chassis for receiving the quasistatic signal generated by the transmitter. The generated quasistatic field enables communication restricted to the physical proximity of the display chassis, providing a secure, low-power communication link. The AC signal frequency at the transmitter can be set to correspond to the resonant frequency of the display chassis, thereby amplifying the generated quasistatic field and improving communication efficiency. The system can further include a passive component configured as an inductor coupled in series with the transmitter or the receiver, or both, creating an LC resonant circuit to boost the voltage of the generated quasistatic field along the display chassis. The system can further include a transformer in the transmitter, receiver, or both, to increase the voltage applied to or received from the chassis, thereby enhancing the strength of the quasistatic signal. The transmitter and receiver utilize a frequency and power level that complies with wireless regulations to avoid requiring standard regulatory wireless frequency masks. The system further includes a bandpass filter positioned between the second electrode and the receiver circuit, said filter configured to attenuate interference from other circuits within the display device, thereby isolating the desired quasistatic signal.

The receiver electrode is configured with a shape optimized to maximize the received power from the quasistatic field, thereby enhancing the power transfer efficiency within the display chassis. The system further includes an adaptive matching network coupled to the receiver or transmitter, or both, to optimize power transfer by maximizing the received power through tuning to the resonant frequency of the chassis or a quasistatic excitation frequency.

The transmitter and receiver electrodes are shaped as parallel plates, side-by-side electrodes, or wire electrodes to optimize coupling efficiency with the display chassis and minimize communication channel loss. The quasistatic field generated by the transmitter is designed to operate at a frequency below the resonant frequency of the display chassis, allowing the field to remain confined within the immediate vicinity of the chassis and minimizing external signal leakage. The inductor is configured to provide resonant peaking at a specific frequency to increase the voltage potential difference across the transmitter electrodes, further enhancing the quasistatic field strength across the chassis. The transformer in the transmitter is configured between the power source and the AC signal input to the transmitter electrode, maximizing voltage amplification before it couples to the display chassis.

The transformer in the receiver is positioned between the receiver electrode and the input of the receiver circuitry, allowing voltage amplification of the received signal for improved signal-to-noise ratio and data accuracy. The electrodes used in the transmitter or receiver are further optimized with variable shapes, including planar geometries and contoured profiles, to achieve specific impedance characteristics and enhance capacitive coupling efficiency with the display chassis. The bandpass filter (BPF) is configured to match the high input impedance of the receiver electrode and the output impedance of the receiver circuitry, minimizing insertion loss while selectively filtering out unwanted interference from internal display circuits.

The system further includes a control circuit configured to monitor the operational frequency and dynamically adjust the frequency of the AC signal to maintain optimal quasistatic coupling in the presence of variable load conditions on the display chassis.

The system further includes the energy harvesting circuit which comprises a matched rectifier and a storage capacitor configured to store energy harvested from the quasistatic field, ensuring a consistent power supply to the receiver circuitry.

The shape of the receiver electrode is adjusted to a larger surface area, thereby enhancing its ability to capture a greater portion of the quasistatic field, improving link margin and signal quality.

The adaptive matching network comprises tunable capacitors or inductors to maintain resonance and optimize power transfer efficiency in response to changes in environmental or operating conditions around the display chassis.

The system further includes a housing structure that holds the transmitter and receiver electrodes in a specific orientation relative to the chassis, enhancing the stability of the capacitive coupling and optimizing field confinement along the display body.

The LC resonance created by the inductor and the effective capacitance of the transmitter or receiver electrodes is dynamically adjusted to maintain voltage peaking under varying signal conditions, thus improving communication robustness.

The energy harvesting circuit further comprises a voltage regulation module to maintain a stable voltage output from the harvested energy, allowing uninterrupted operation of the receiver or transmitter circuitry.

The transmitter and receiver electrodes are positioned in a parallel plate configuration to enhance electric field uniformity along the chassis, thereby minimizing energy losses and maximizing signal fidelity.

The transmitter and receiver are further configured with multiple electrode pairs, enabling simultaneous multi-channel communication between the transmitter and receiver for higher data transfer rates.

The transmitter is further configured to support multiple communication protocols, allowing peripheral devices of different standards to communicate securely through the quasistatic field generated by the display chassis.

The energy harvesting circuit is configured with a switching mechanism to draw energy selectively from the quasistatic field or an auxiliary power source, depending on power availability, to enhance power reliability for the device.

The system further includes a monitoring module configured to detect variations in the strength of the quasistatic field and adjust the transmitter's power output accordingly, thus maintaining optimal signal strength. The energy harvesting circuit further comprises an impedance communication within the chassis for secure communication.

The energy harvesting circuit further comprises a matching network to improve rectification efficiency, thereby increasing the harvested power from the quasistatic field and ensuring reliable energy capture.

The transmitter and receiver electrodes are arranged in an asymmetric configuration relative to the display chassis to selectively direct the quasistatic field towards specific peripheral devices, improving communication precision and signal integrity.

The system further includes a signal feedback mechanism configured to detect changes in chassis resonance and adjust the frequency of the transmitter AC signal in response, thereby maintaining efficient quasistatic field generation for stable communication.

One of the ordinary skills in the art will appreciate that techniques consistent with the present disclosure are applicable in other contexts as well without departing from the scope of the disclosure.

What has been described and illustrated herein are examples of the present disclosure. The terms, descriptions, and figures used herein are set forth by way of illustration only and are not meant as limitations. Many variations are possible within the spirit and scope of the subject matter, which is intended to be defined by the following claims and their equivalents in which all terms are meant in their broadest reasonable sense unless otherwise indicated.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein may comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium may be any apparatus that may comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries may be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a”, “an”, and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A quasistatic electromagnetic field communication system comprising:
a transmitting power source comprising one or more optimizable transmitter electrodes, capacitively coupled with a chassis body of one or more connected devices, wherein the transmitting power source is configured to:
transmit one or more data signals to the one or more connected devices through the chassis body associated with the one or more connected devices; and
perform excitation of the chassis body with a current signal, for generating a quasistatic field along the chassis body based on the transmission;
the chassis body further comprising a conducting medium, wherein the conducting medium of the chassis body is configured to create one or more quasistatic field signals upon the excitation of the chassis body; and
a receiving device comprising:
one or more optimizable receiver electrodes, capacitively coupled with the chassis body and an output panel of the one or more connected devices; and
one or more filters coupled with the one or more optimizable receiver electrodes associated with the receiving device;
wherein the receiving device is configured to:
receive the one or more quasistatic field signals from the chassis body;
perform filtration of the received one or more quasistatic field signals by filtering the one or more quasistatic field signals which are out of predefined operating range; and
receive the one or more transmitted data signals based on the performed filtration; and
output the received one or more signals to the output panel of the one or more connected devices.

2. The quasistatic electromagnetic field communication system of claim 1, wherein the one or more transmitted data signals comprises at least video signals, audio signals, light signals and sensor signals.

3. The quasistatic electromagnetic field communication system of claim 1, wherein to perform the excitation of the chassis body based on the transmitted one or more data signals, the transmitting power source is configured to:
determine a resonance value of the chassis body;
perform boosting of the one or more transmitted data signals based on the determined resonance value of the chassis body, by using a passive component configured as an inductor coupled in series with the one or more optimizable transmitter electrodes creating an LC resonant circuit, wherein the passive component is configured to boost a voltage of the generated quasistatic field along the display chassis, wherein the inductor is configured to perform resonant peaking at a specific frequency to increase a voltage potential difference across the transmitter electrodes;
transmit the one or more boosted data signals to the chassis body; and
perform the excitation of the chassis body based on the transmission.

4. The quasistatic electromagnetic field communication system of claim 1, wherein the receiving device is configured to adjust the one or more optimizable receiver electrodes associated with the receiving device, data signals.

5. The quasistatic electromagnetic field communication system of claim 1, wherein the transmitting power source is capacitively coupled with the chassis body of the one or more connected devices, by grounding the one or more optimizable transmitter electrodes to the chassis body of the one or more connected devices.

6. The quasistatic electromagnetic field communication system of claim 1, wherein to capacitively couple with the chassis body and the output panel of the one or more connected devices, the receiving device is configured to:
perform capacitive coupling with the chassis body of the one or more connected devices, by shorting one or more ground reference electrodes of the one or more optimizable receiver electrodes to the chassis body of the one or more connected devices; and
perform capacitive coupling with the output panel of the one or more connected devices by placing one or more signal input electrodes of the one or more optimizable receiver electrodes parallel to the chassis body of the one or more connected devices.

7. The quasistatic electromagnetic field communication system of claim 1, comprising an adaptive matching network coupled to at least one of the transmitter power source and the receiver device, to adjust power transfer by maximizing the received power through tuning to one of the resonant frequency of the chassis and a quasistatic excitation frequency.

8. The quasistatic electromagnetic field communication system of claim 1, wherein the one or more filters comprises:
a bandpass filter placed between the one or more optimizable receiver electrodes associated with the receiving device and an input terminal of the receiving device, wherein the bandpass filter configured to attenuate interference from other circuits within the display device.

9. The quasistatic electromagnetic field communication system of claim 1, comprising:
one or more transformers placed around the one or more optimizable transmitter electrodes connected to the transmitting power source, wherein the one or more transformers are configured to increase the voltage of the one or more data signals transmitted from the transmitting power source.

10. The quasistatic electromagnetic field communication system of claim 1, wherein the quasistatic field generated by the transmitting power source is configured to operate at a frequency below a resonant frequency of the chassis body.

11. The quasistatic electromagnetic field communication system of claim 1, comprising:
a control circuit configured to monitor the operational frequency and dynamically adjust the frequency of the current signal to maintain optimal quasistatic coupling in presence of variable load conditions on the chassis body.

12. The quasistatic electromagnetic field communication system of claim 1, comprising:
an energy harvesting circuit comprising a matched rectifier and a storage capacitor configured to store energy harvested from the quasistatic field, wherein the energy harvesting circuit is configured with a switching mechanism to selectively apply power from one of the quasistatic field and an auxiliary power source, depending on power availability.

13. A method for quasistatic electromagnetic field communication, comprising:
transmitting, by a transmitting power source, one or more data signals to one or more connected devices through a chassis body associated with the one or more connected devices;
performing, by the transmitting power source, excitation of the chassis body with a current signal, for generating a quasistatic field along the chassis body based on the transmission;
creating, by the chassis body, one or more quasistatic field signals upon the excitation of the chassis body;
receiving, by a receiving device, the one or more quasistatic field signals from the chassis body;
performing, by the receiving device, filtration of the received one or more quasistatic field signals by filtering the one or more quasistatic field signals which are out of predefined operating range; and
receiving, by the receiving device, the one or more transmitted data signals based on the performed filtration; and
outputting, by the receiving device, the one or more received data signals to an output panel of the one or more connected devices.

14. The method of claim 13, wherein the one or more transmitted data signals comprises at least video signals, audio signals, light signals and sensor signals.

15. The method of claim 13, wherein performing the excitation of the chassis body based on the transmitted one or more data signals, further comprising:
determining, by the transmitting power source, a resonance value of the chassis body;
performing, by the transmitting power source, boosting of the one or more transmitted data signals based on the determined resonance value of the chassis body, by using a passive component configured as an inductor coupled in series with the one or more optimizable transmitter electrodes creating an LC resonant circuit, wherein the passive component is configured to boost a voltage of the generated quasistatic field along the display chassis, wherein the inductor is configured to perform resonant peaking at a specific frequency to increase a voltage potential difference across the transmitter electrodes;
transmitting, by the transmitting power source, the one or more boosted data signals to the chassis body; and
performing, by the transmitting power source, the excitation of the chassis body based on the transmission.

16. The method of claim 13, wherein the receiving device is configured to adjust the one or more optimizable receiver electrodes associated with the receiving device, to increase the maximum power of the received one or more transmitted data signals.

17. The method of claim 13, wherein the transmitting power source is capacitively coupled with the chassis body of the one or more connected devices, by grounding the one or more optimizable transmitter electrodes to the chassis body of the one or more connected devices.

18. The method of claim 13, wherein capacitively coupling of the receiving device with the chassis body and the output panel of the one or more connected devices, comprising:
performing, by the receiving device, capacitive coupling with the chassis body of the one or more connected devices, by shorting one or more ground reference electrodes of the one or more optimizable receiver electrodes to the chassis body of the one or more connected devices; and
performing, by the receiving device, capacitive coupling with the output panel of the one or more connected devices by placing one or more signal input electrodes of the one or more optimizable receiver electrodes parallel to the chassis body of the one or more connected devices.

19. The method of claim 13, comprising:
attenuating, by a band pass filter, interference from other circuits within the display device, wherein the bandpass filter is placed between the one or more optimizable receiver electrodes associated with the receiving device and an input terminal of the receiving device.

20. A non-transitory computer-readable medium comprising machine-readable instructions that are executable by a processor to:
transmit one or more data signals to one or more connected devices through a chassis body associated with the one or more connected devices;
perform excitation of the chassis body based on the transmission;
create one or more quasistatic field signals upon the excitation of the chassis body;
receive the one or more quasistatic field signals from the chassis body;
perform filtration of the received one or more quasistatic field signals by filtering the one or more quasistatic field signals which are out of predefined operating range;
receive the one or more transmitted data signals based on the performed filtration; and
output the one or more received data signals to an output panel of the one or more connected devices.
